(19) United States
(12) Patent Application Publication
(10) Pub. No.: US 2012/0271589 A1
(43) Pub. Date: Oct. 25, 2012

(54) INFORMATION PROCESSING APPARATUS AND METHOD

(75) Inventors: Shinichi Nagano, Kanagawa-ken (JP); Kenta Sasaki, Tokyo (JP); Yuzo Okamoto, Kanagawa-ken (JP); Kenta Cho, Kanagawa-ken (JP)

(73) Assignee: KABUSHIKI KAISHA TOSHIBA, Tokyo (JP)

(21) Appl. No.: 13/410,641

(22) Filed: Mar. 2, 2012

(30) Foreign Application Priority Data
Apr. 25, 2011 (JP) 2011-097463

(51) Int. Cl. G06F 15/00; G01P 15/00

(52) U.S. Cl. 702/141

(57) ABSTRACT

According to one embodiment, an information processing apparatus extracts utterance information of at least one user who utilizes a network community from a server. The information processing apparatus includes a measurement unit, an estimation unit, an extraction unit, and a display unit. The measurement unit is configured to measure a present location and an acceleration representing a rate of a specific user's move. The estimation unit is configured to estimate a moving status of the specific user based on the acceleration, and to estimate a line information which the specific user is presently utilizing or will utilize based on the present location and the moving status. The extraction unit is configured to extract at least one utterance information related to the line information from the server. The display unit is configured to display the utterance information extracted.

### CROSS-REFERENCE TO RELATED APPLICATION

This application is based upon and claims the benefit of priority from Japanese Patent Application No. 2011-097463, filed on Apr. 25, 2011; the entire contents of which are incorporated herein by reference.

### FIELD

Embodiments described herein relate generally to an information processing apparatus and a method thereof.

### BACKGROUND

An information processing device for presenting various information (such as a transfer guidance) to a user is widely used. For example, the user's present location is measured by a GPS or an acceleration sensor, a railway line on which the user is presently boarding is estimated, and the transfer guidance for the railway line is presented. This device is used in a personal digital assistant (such as a smart phone).

In conventional technique, as to this device, a congestion status of a railway where the user is presently boarding or a status in a train at an emergency time (such as accident) cannot be presented to the user.

Furthermore, from a network community (For example, Internet community) which a plurality of users can mutually send and share, an information processing device for exacting utterance information and presenting to a user is well known. This device is also used in a personal digital assistant (such as a smart phone).

In conventional technique, information (uttered by at least one user) related to a specific line cannot be extracted from the network community.

### BRIEF DESCRIPTION OF THE DRAWINGS

FIG. 1 is a block diagram of an information processing apparatus 1 and a server 5 according to a first embodiment.

FIG. 2 is one example of utterance information stored in an utterance storage unit 62 in FIG. 1.

FIG. 3 is a flow chart of processing of the information processing apparatus 1 according to the first embodiment.

FIG. 4 is a flowchart of processing of an extraction unit in FIG. 1.

FIG. 5 is one example of utterance information extracted by the extraction unit 12.

FIG. 6 is a display example of the utterance information on a display unit 13.

FIG. 7 is another display example of the utterance information on a display unit 13.

FIG. 8 is a block diagram of an information processing apparatus 1 and a server 5 according to a second embodiment.

FIG. 9 is a flow chart of processing of the information processing apparatus 1 according to the second embodiment.

FIG. 10 is one example of user A's utterance information stored in a user utterance storage unit 63 in FIG. 8.

FIG. 11 is a block diagram of an information processing apparatus 1 and a server 5 according to a third embodiment.

FIG. 12 is a flow chart of processing of a keyword extraction unit 31 in FIG. 11.

FIG. 13 is one example of utterance information extracted by the extraction unit 12 and the keyword extraction unit 31.

### DETAILED DESCRIPTION

According to one embodiment, an information processing apparatus extracts utterance information of at least one user who utilizes a network community from a server. The information processing apparatus includes a measurement unit, an estimation unit, an extraction unit, and a display unit. The measurement unit is configured to measure a present location and an acceleration representing a rate of a specific user's move. The estimation unit is configured to estimate a moving status of the specific user based on the acceleration, and to estimate a line information which the specific user is presently utilizing or will utilize based on the present location and the moving status. The extraction unit is configured to extract at least one utterance information related to the line information from the server. The display unit is configured to display the utterance information extracted.

Various embodiments will be described hereinafter with reference to the accompanying drawings.

### The First Embodiment

An information processing apparatus 1 of the first embodiment can be used for a personal digital assistant (PDA) or a personal computer (PC). For example, the information processing apparatus 1 can be used by a user who is utilizing a railway or will utilize the railway from now on.

As to a user A who is utilizing a network community by the information processing apparatus 1, this apparatus 1 presents utterances (written by at least one user who utilizing the network community) related to operation status of one line of a specific railway. The operation status includes, for example, a delay status of the railway or a status such as congestion degree in a train. The term “utterance” includes the posted content from a plurality of users.

Based on a present location of a moving status of the user A, the information processing apparatus 1 estimates one railway line which the user A is utilizing or will utilize from now on, extracts utterance information (explained afterwards) related to operation status of the estimated line from at least one user's utterance stored in a server 5 (explained afterwards), and presents the utterance information. In the first embodiment, “utterance” represents user's writing a comment into the network community.

As a result, the user A can easily know the operation status of the railway line which the user A is presently utilizing or will utilize from now on.

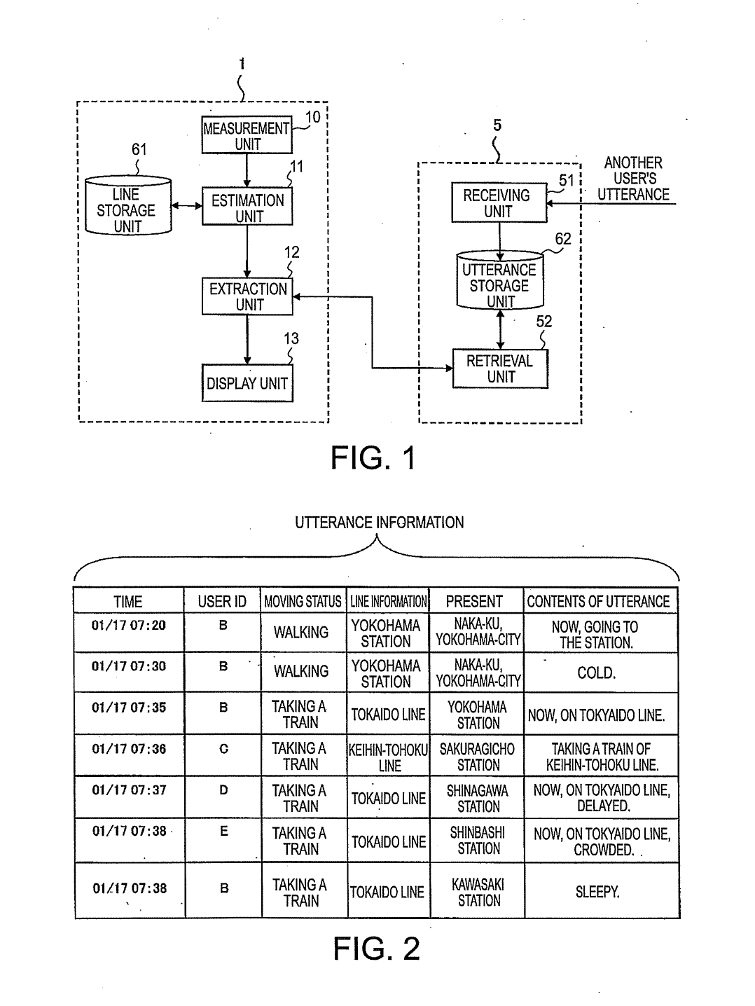

FIG. 1 is a block diagram of the information processing apparatus 1 and the server 5. The information processing apparatus 1 includes a measurement unit 10, an estimation unit 11, an extraction unit 12, a display unit 13, and a line storage unit 61. The server 5 includes a receiving unit 51, a retrieval unit 52, and an utterance storage unit 62.

<As to Server 5>

The utterance storage unit 62 stores utterance information of at least one user who is utilizing the network community. FIG. 2 shows one example of utterance information stored in the utterance storage unit 62. The utterance information correspondingly includes contents of an utterance of at least one user (who is utilizing the network community), a time when the user has written the utterance, and ID of the user. In the first embodiment, the utterance information further correspondingly includes a moving status of the user at the time, (railway) line information of a train which the user is taking at the time, and a present location of the user at the time. In FIG. 2, user ID “B, C, D, E” represents four different users.

The receiving unit 51 receives an utterance of at least one user (who is utilizing the network community), and writes utterance information (contents of the utterance, a time of the utterance, a user ID of the user, a moving status of the user at the time, a present location of the user at the time) into the utterance storage unit 62. The receiving unit 51 may update the utterance information whenever a new utterance is received from the user. Alternatively, the receiving unit 51 may update the utterance information at a predetermined interval.

Based on a request from the extraction unit 12 (explained afterwards), the retrieval unit 52 acquires at least one utterance information from the utterance storage unit 62, and supplies the utterance information to the extraction unit 12.

<As to the Information Processing Apparatus 1>

The line storage unit 61 stores station names and (railway) line names corresponding to each location information thereof. The location information may be represented by a coordinate system (such as longitude and latitude) based on a specific place.

The measurement unit 10 measures a present location and an acceleration of the user A. The measurement unit 10 may measure the present location using GPS and the acceleration using an acceleration sensor.

Based on the acceleration, the estimation unit 11 estimates that the user A's moving status is taking a train, walking, or resting. By referring to the line storage unit 61, based on change of the user A's present location in a predetermined period and the estimated moving status, the estimation unit 11 estimates line information of a railway used by the user A.

The line information includes a line name of a railway used by the user A, an advance direction of the train thereon, and a name of a neighboring station. For example, if the moving status is “taking a train”, the estimation unit 11 may estimate a train status or a railway status, that is a line of the train, an advance direction thereof, and the neighboring station. Furthermore, if the moving status is “walking” or “resting”, the estimation unit 11 may estimate the neighboring station. Moreover, the present location may be an address or a station name in a coordinate system (such as longitude and latitude) based on a specific place.

Based on the moving status and the line information estimated, the estimation unit 12 requests the retrieval unit 52 of the user 5 to retrieve utterance information related to operation status of a railway which the user A is utilizing or will utilize from now on, and extracts the utterance information. Detail processing thereof is explained afterwards.

The display unit 13 displays the utterance information extracted.

The measurement unit 10, the estimation unit 12, the display unit 13, and the retrieval unit 52, may be realized by a central processing unit (CPU) and a memory used thereby. The line storage unit 61 and the utterance storage unit 62 may be realized by the memory or an auxiliary storage unit.

As mentioned-above, component of the information processing apparatus 1 is already explained.

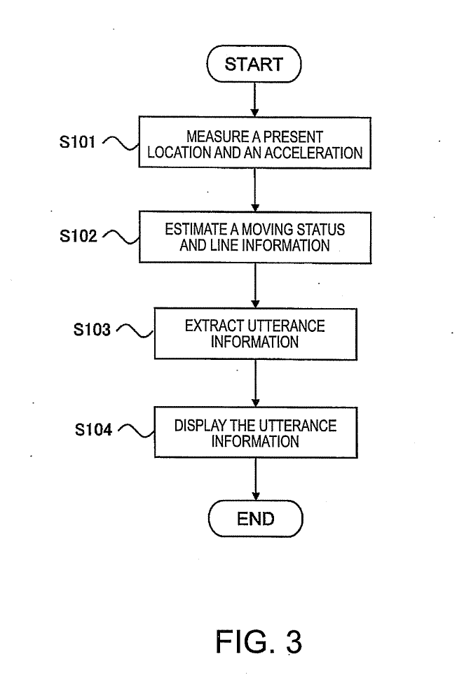

FIG. 3 is a flow chart of processing of the information processing apparatus 1. The measurement unit 10 measures a present location and an acceleration of the user A (S101).

Based on the present location and the acceleration, the estimation unit 11 estimates the user A's moving status and line information (S102). If the present location is a station and the station locates on a plurality of railway lines, the estimation unit 11 may estimate one line using a timetable, or all lines as candidates.

Based on the moving status and the line information, the extraction unit 12 extracts utterance information related to operation status of the estimated line from the server 5 (S103). The display unit 13 displays the utterance information extracted (S104).

As mentioned-above, processing of the information processing apparatus 1 is already explained.

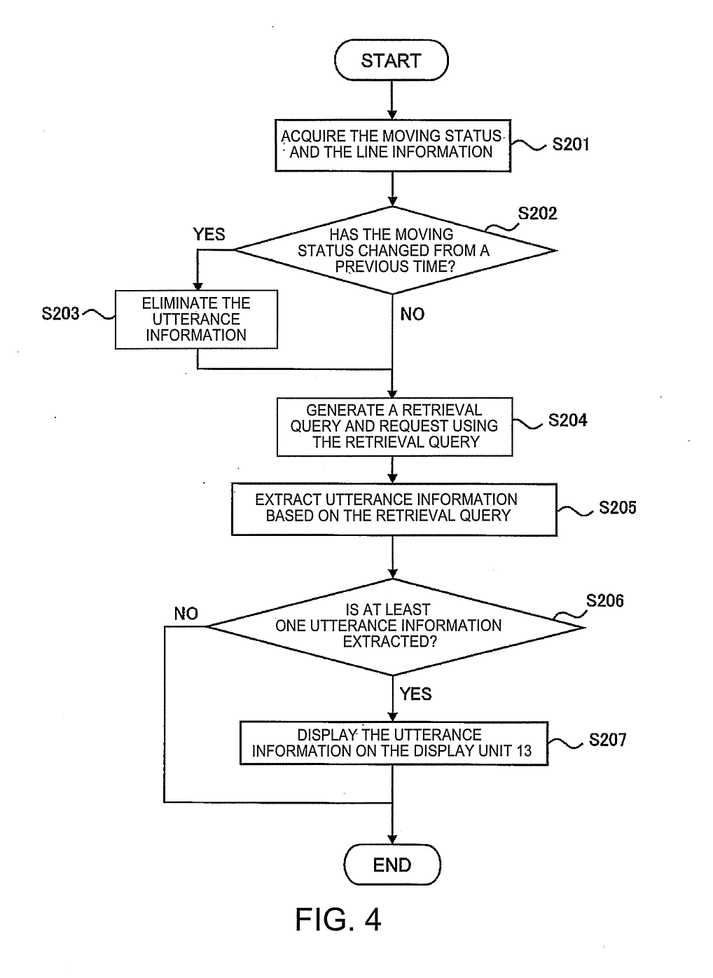

Next, detail processing of the extraction unit 12 is explained. FIG. 4 is a flow chart of processing of the extraction unit 12. The extraction unit 12 acquires the user's present moving status and the line information from the estimation unit 11 (S201). The extraction unit 12 decides whether the moving status changes from a previous time (S202). Therefore, the extraction unit 12 had better write the moving status into a memory (not shown in Fig.) at the previous time.

If the moving status does not change from the previous time (No at S202), based on the moving status and the line information, the extraction unit 12 generates a retrieval query to extract utterance information related to operation status of a railway which the user A is utilizing or may utilize hereafter, and requests the retrieval unit 52 of the server 5 to retrieve (S204). If the moving status changed from the previous time (Yes at S202), the extraction unit 12 eliminates the utterance information displayed on the display unit 12 (S203), and processing is transited to S204.

At S204, if the moving status is “taking a train”, the extraction unit 12 generates a retrieval query by using a railway name (line name) which the user A is utilizing and a name of a next arrival station (arrival station name) as keywords. Briefly, the retrieval query is a query to retrieve utterance information corresponding to “contents of utterance” and “line information” including the line name or the arrival station name. The arrival station name may be estimated from change of the present location and the neighboring station name.

At S204, if the moving status is “walking” or “resting”, the extraction unit 12 generates a retrieval query by using the neighboring station name as a keyword. Briefly, this retrieval query is a query to retrieve utterance information corresponding to “contents of utterance” and “line information” including the neighboring station name.

The extraction unit 12 extracts utterance information based on the retrieval query (S205). In this case, at the server side 5, the retrieval unit 52 acquires contents of at least one utterance based on the retrieval query from the utterance storage unit 62, and supplies the contents to the extraction unit 12. As a result, the extraction unit 12 can extract utterance information from the retrieval unit 52.

Moreover, at S204, the extraction unit 12 may generate a retrieval query to request utterance information in a predetermined period prior to the present time. As a result, only utterance information written nearby at the present time can be extracted.

Furthermore, at S205, the extraction unit 12 may perform a text analysis (For example, natural language processing such as a morphological analysis) to the utterance information extracted, and decide whether the utterance information is selected. For example, utterance information from which “the user A is presently utilizing a railway” or “the user A is presently staying at a station” is estimated may be remained by cancelling other utterance information. Alternatively, based on a predetermined rule of order of words, the utterance information extracted may be decided whether to be selected. In this case, for example, utterance information including a station name at the head of a sentence therein may be remained by cancelling other utterance information.

For example, as a method for estimating that the user is presently utilizing a railway or the user is presently staying at a station, a word “NOW”, a word “˜ing” representing “being in progress”, or the tense (present, past, future) of a sentence, may be detected.

Furthermore, at S205, the extraction unit 12 may select utterance information including a moving status matched with the user A's present moving status, and not select (cancel) other utterance information. As a result, without text analysis, an utterance of another user who is under the same status as the user A can be known.

The extraction unit 12 decides whether at least one utterance information is extracted (S206). If the at least one utterance information is extracted (Yes at S206), the extraction unit 12 displays the utterance information via the display unit 13 (S207), and processing is completed. In this case, the extraction unit 12 may display the utterance information in order of utterance time.

If no utterance information is extracted (No at S206), the extraction unit 12 completes the processing. The extraction unit 12 may repeats the above-mentioned processing at a predetermined interval until a completion indication is received from the user A.

In the first embodiment, for example, assume that the moving status is “TAKING A TRAIN”, the line information is “TOKAIDO LINE”, and the moving status does not change from a previous time. Processing of the extraction unit 12 in FIG. 4 is explained by referring to utterance information in FIG. 2.

At S201, the extraction unit 12 acquires the moving status “TAXING A TRAIN” and the line information “TOKAIDO LINE” from the estimation unit 11. The moving status does not change from the previous time. Accordingly, decision at S202 is NO, and processing is transited to S204.

At S204, the extraction unit 12 generates a retrieval query by using “TOKAIDO LINE” (line name) as a keyword. Briefly, this retrieval query is a query to retrieve utterance information corresponding to “contents of utterance” and “line information” including the keyword “TOKAIDO LINE”.

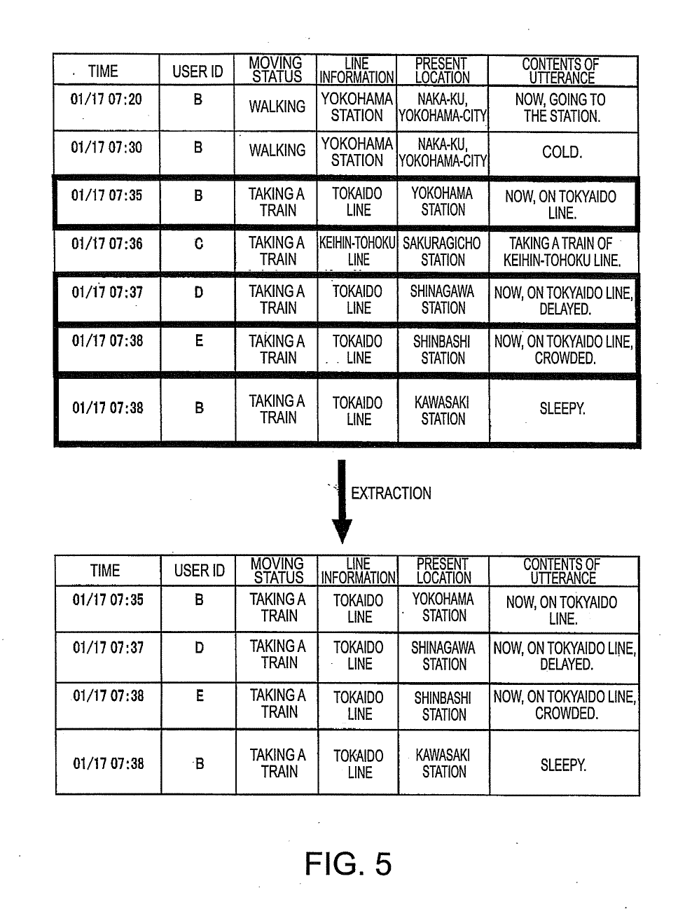

By referring to the utterance storage unit 62, the retrieval unit 52 at the server side 5 acquires utterance info illation including the keyword “TOKAIDO LINE”. At S205, the extraction unit 12 extracts the utterance information acquired by the retrieval unit 52. FIG. 5 shows one example of utterance information extracted by the extraction unit 12 from utterance information shown in FIG. 2. In FIG. 5, the extraction unit 12 extracts four utterances (surrounded by thick line) acquired by the retrieval unit 52, because the four utterances include the keyword “TOKAIDO LINE”.

In this case, at least one utterance is already extracted. Accordingly, decision at S206 is YES, and processing is transited to S207.

At S207, the extraction unit 12 displays the utterance information extracted (shown in lower side of FIG. 5) via the display unit 13. Here, processing of this example is completed.

As mentioned-above, processing of the extraction unit 12 and one example thereof are already explained.

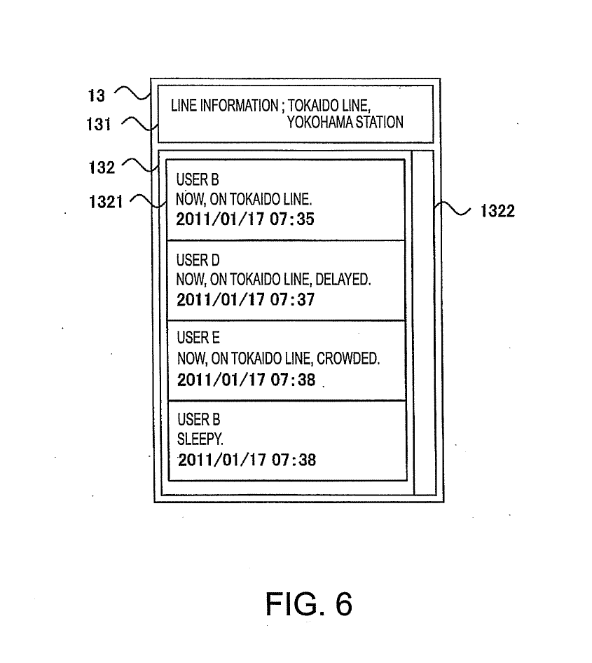

FIG. 6 shows a display example of the display unit 13. In this display example, utterance information based on the user A's moving status and present location is presented to the user A. The display unit 13 includes a display header part 131 and an utterance display part 132. The display header part 131 displays line information estimated by the estimation unit 12. The utterance display part 132 displays utterance information (shown in lower side of FIG. 5) extracted by the extraction unit 12.

The utterance display part 132 includes at least one utterance information 1321 and a scroll bar 1322 to read utterance information outside (not displayed in) the utterance display part 132. The utterance information 1321 had better include at least a user ID, contents of utterance, and a time in the utterance information of FIG. 2. The scroll bar 1322 can scroll the utterance information by, for example, an operation with a keyboard on the information processing apparatus 1, or an operation to touch onto the display unit 13.

For example, in FIG. 6, the display header unit 131 represents that the user A's present line information is “TOKAIDO LINE”. Furthermore, the utterance display unit 132 may display four utterances 1321 (including “TOKAIDO LINE”) in early order of time.

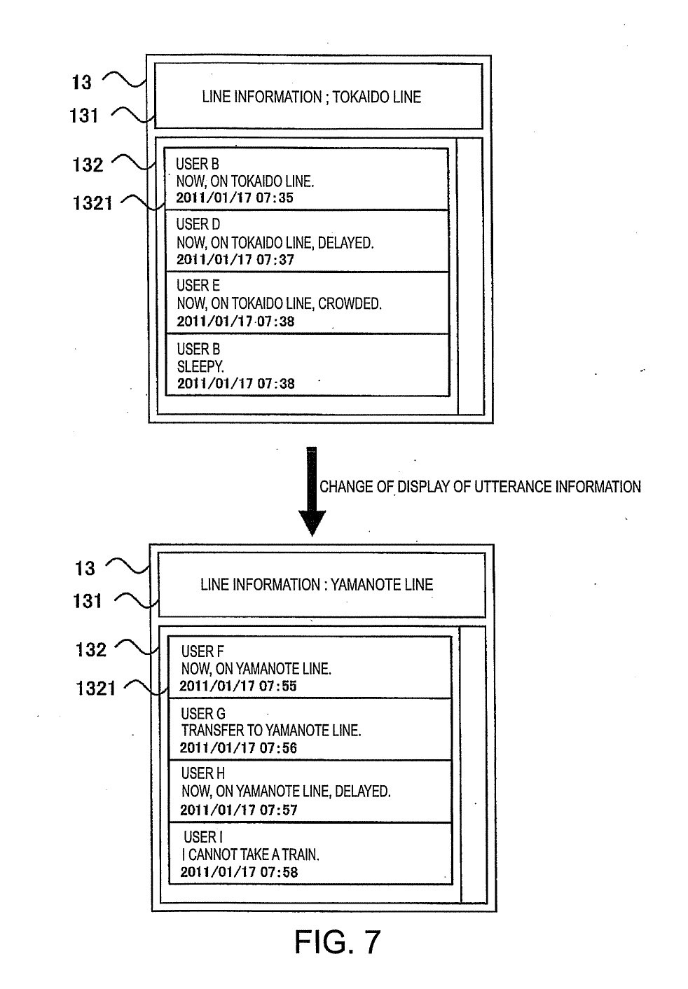

FIG. 7 shows one example that utterance information displayed (on the display unit 13 at S207) changes when the line information has changed from a previous time (No at S202) in a flow chart of FIG. 4. An upper side of FIG. 7 shows a display example before the user A's line information changes, which the user A's present line is “TOKAIDO LINE” and four utterances including contents of “TOKAIDO LINE” are displayed. On the other hand, a lower side of FIG. 7 shows a display example after the user A's line information has changed, which the user A's present line is “YAMANOTE LINE” and four utterances including contents of “YAMANOTE LINE” are displayed.

The extraction unit 12 executes processing of the flow chart of FIG. 4 at a predetermined interval, and detects that the user A transfers (changes) from “TOKAIDO LINE” to “YAMANOTE LINE” at S201. In this case, first, utterance information displayed on the display unit 13 is eliminated (S203). Then, a retrieval query including “YAMANOTE LINE” (as the user A's line information after the user A has transferred) is generated (S204), utterance information is extracted using the retrieval query (S205), and the utterance information is displayed on the display unit 13 (S206, S207).

In this way, as to the information processing apparatus 1, utterance information based on the user A's line information is displayed on the display unit 12. Furthermore, without explicitly inputting the present line information by the user A, by following change of the user A's line information, the displayed utterance information is switched to utterance information based on the present line information.

In the first embodiment, an operation status of a railway which the user A is presently utilizing or will utilize from now on can be collected without explicitly retrieving another user's utterance who is utilizing the railway, and the user A can confirm contents of the operation status.

Moreover, in the first embodiment, a railway is explained as an example. However, a traffic route having a regular service such as a bus, a ship or an air plain, may be used.

(Modification)

In the first embodiment, the measurement unit 10, the estimation unit 11, the extraction unit 12, the display unit 13 and the line storage unit 61 are located at a side of the information processing apparatus 1. However, component of the information processing apparatus 1 is not limited to this component. For example, the information processing apparatus 1 may include the measurement unit 10 and the display unit 13 while the server 5 may include the estimation unit 11, the extraction unit 12 and the line storage unit 61. In this modification example, at the server 5, by executing processing of S102-S103 in FIG. 3, the first embodiment is used as a service to utilize a cloud.

### The Second Embodiment

As to an information processing apparatus 2 of the second embodiment, in addition to line information, based on an utterance inputted by the user A, utterance information related to operation status of a railway is extracted from at least one user's utterances. This feature is different from the first embodiment.

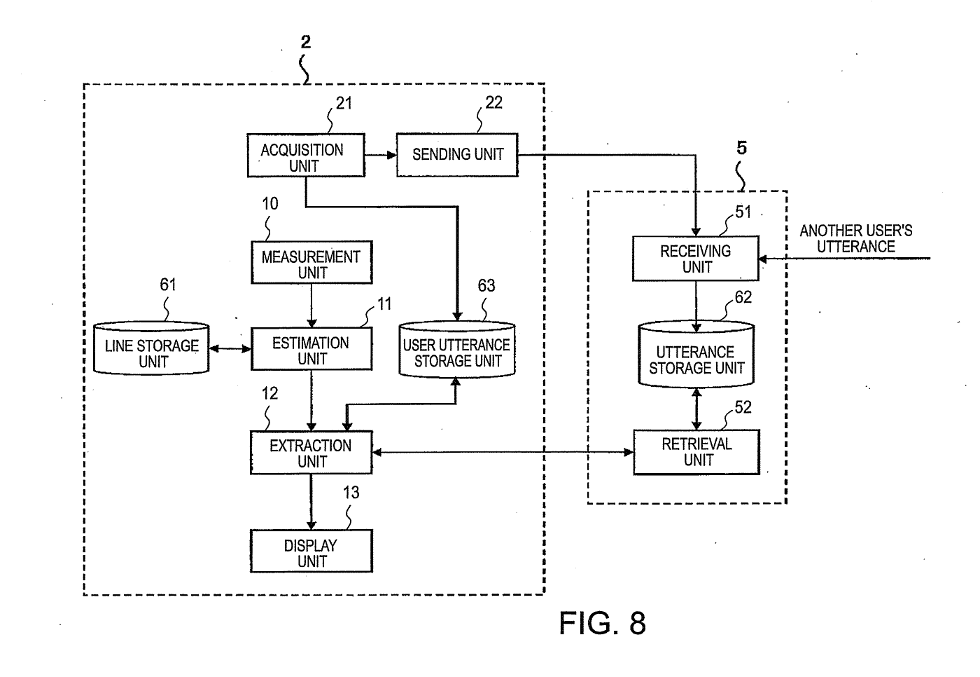

FIG. 8 is a block diagram of the information processing apparatus 2 and the server 5 according to the second embodiment. In comparison with the information processing apparatus 1, the information processing apparatus 2 further includes an acquisition unit 21, a sending unit 22, and a user utterance storage unit 63. Furthermore, processing of the extraction unit 12 is different from that of the first embodiment.

The acquisition unit 21 acquires the user A's utterance. For example, the acquisition unit 21 may acquire the user A's utterance by a keyboard input, a touch pen input, or a speech input.

The sending unit 22 sends the user A's utterance to the receiving unit 51 of the server 5. The receiving unit 51 writes the received utterance into the utterance storage unit 62.

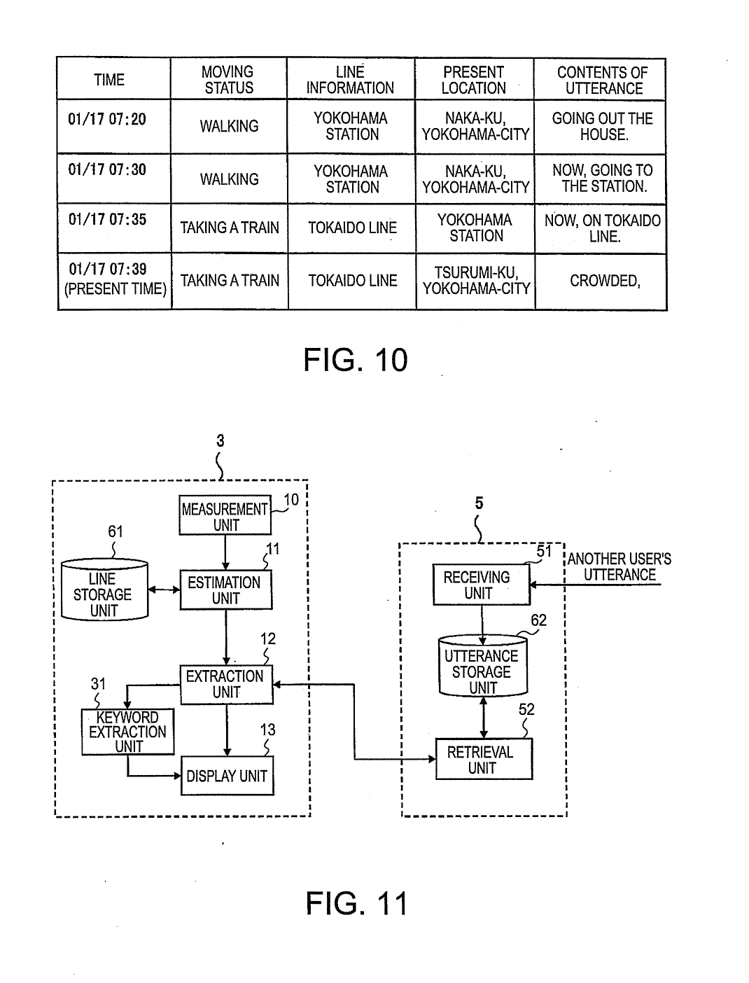

The user utterance storage unit 63 stores the user A's utterance information acquired. FIG. 10 shows one example of the user A's utterance information stored in the user utterance storage unit 63. The user utterance storage unit 63 stores contents of utterance in correspondence with a time when the user A has inputted the utterance, the user A's moving status at the time, and the user A's location at the time.

Based on line information and the user A's utterance information, the extraction unit 12 extracts utterance information related to operation status of a railway from the server 5.

As mentioned-above, component of the information processing apparatus 2 is already explained.

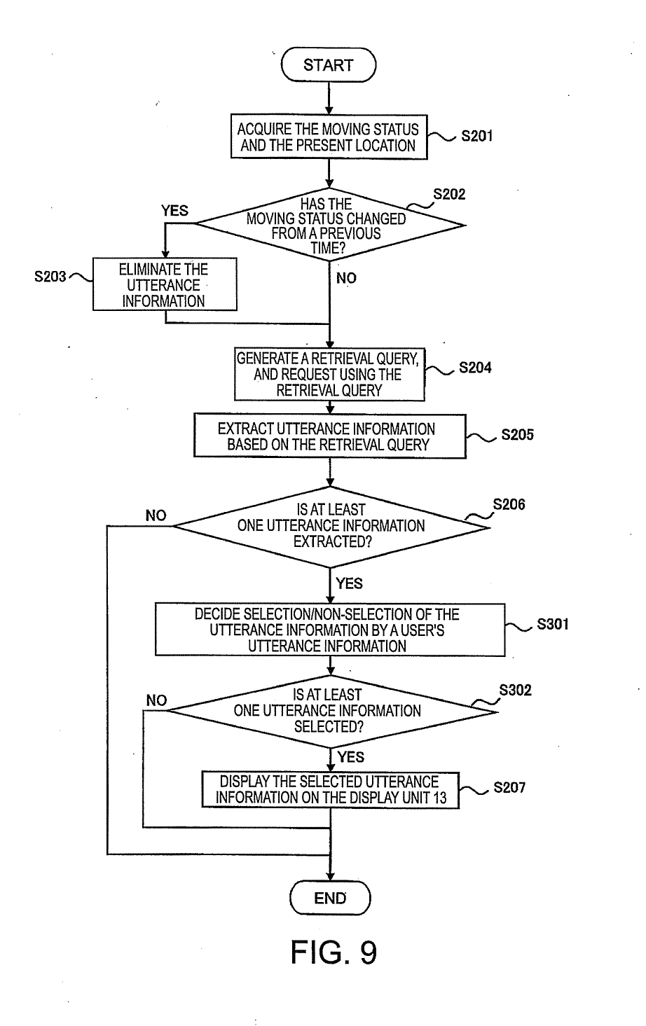

FIG. 9 is a flow chart of processing of the extraction unit 12 according to the second embodiment. The flow chart of FIG. 9 includes S301 and S302 in addition to the flow chart of FIG. 4. Other steps in FIG. 9 are same as those in the first embodiment.

At S301, based on at least one utterance information of the user A (stored in the user utterance storage unit 63), the extraction unit 12 decides whether utterance information (extracted at S205) is selected for display (301).

For example, by analyzing a text (For example, natural language processing such as morphological analysis) of the user A's utterance information stored in the user utterance storage unit 63, the extraction unit 12 acquires at least one keyword. Moreover, in this case, the extraction unit 12 may acquire at least one keyword by analyzing a text of utterance information in a predetermined period prior to the present time. Moreover, the keyword may be an independent word such as a noun, a verb, or an adjective.

The extraction unit 12 decides whether the keyword analytically acquired is included in utterance information extracted at S205. If the keyword is included, the utterance information is selected for display. If the keyword is not included, the utterance information is not selected (canceled).

At S302, the extraction unit 12 decides whether at least one utterance information is selected for display. If the at least one utterance information is selected (Yes at S302), processing is transited to S207. If no utterance information is selected (No at S302), the extraction unit 12 completes the processing.

Processing of S301 is explained by referring to utterance information shown in FIGS. 5 and 10. At S301, among the user A's utterance information (stored in the user utterance storage unit 63) shown in FIG. 10, the extraction unit 12 analyzes a text of utterance information (four utterances in FIG. 10) in a predetermined period (For example, five minutes before) prior to the present time. As a result, the extraction unit 12 selects “NOW”, “TOKAIDO LINE” and “CROWDED” as keywords.

The extraction unit 12 decides whether “NOW”, “TOKAIDO LINE” and “CROWDED” are included in utterance information (shown at lower side of FIG. 5) extracted at S205. In this example, among four utterances extracted, an utterance of user ID “E” includes the keywords. Accordingly, the extraction unit 12 selects utterance information of user ID “E” for display, and does not select (cancels) other utterance information. Alternatively, the extraction unit 12 may decide whether any of the keywords is included utterance information.

As mentioned-above, processing of the extraction unit 12 of the second embodiment is already explained.

In the second embodiment, utterance information is extracted by further using the user A's utterance. Accordingly, utterance information matched with the user A's intension can be extracted with higher accuracy, and presented.

### The Third Embodiment

As to an information processing apparatus 3 of the third embodiment, from at least one user's utterance information stored in the server 5, utterance information including the user A's line information is extracted, and keywords related to operation status of railway are extracted from the extracted utterance information. This feature is different from the first and second embodiments.

FIG. 11 is a block diagram of the information processing apparatus 3 and the server 5. In comparison with the information processing apparatus 1, the information processing apparatus 3 further includes a keyword extraction unit 31. Furthermore, processing of the display unit 13 is different from that of the first and second embodiments.

The keyword extraction unit 31 extracts at least one keyword related to operation status of railway from utterance information extracted by the extraction unit 12.

The display unit 13 displays the at least one keyword extracted by the keyword extraction unit 31, in addition to utterance information extracted by the extraction unit 12.

As mentioned-above, component of the information processing apparatus 3 is already explained.

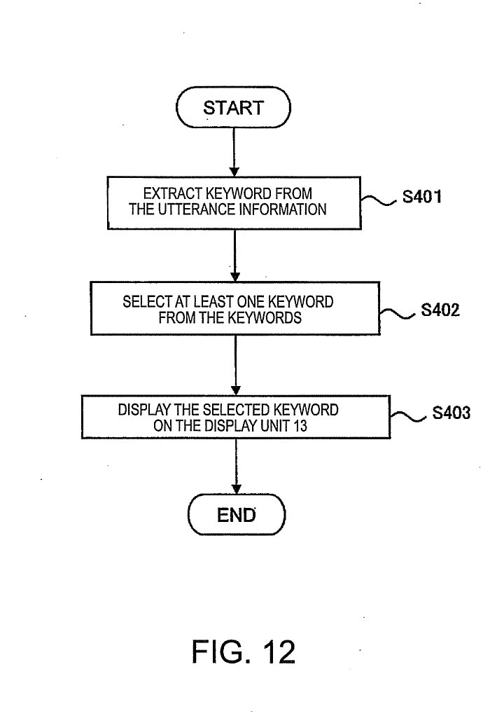

FIG. 12 is a flow chart of processing of the keyword extraction unit 31. In this flow chart, utterance information extracted by the extraction unit 12 is inputted.

The keyword extraction unit 31 acquires at least one keyword by analyzing a text (For example, natural language processing such as morphological analysis) of the utterance information (S401). The keyword may be an independent word sich as a noun, a verb, or an adjective.

As to the keywords extracted, the keyword extraction unit 31 calculates a score of each keyword by a predetermined method, and selects at least one keyword (For example, the predetermined number of keywords from the highest score) in order of higher score (S402). For example, among utterance information extracted by the extraction unit 12, the number of times of appearance of each keyword, i.e., an appearance frequency of each keyword may be the score. Furthermore, from utterance information extracted in a predetermined period by the extraction unit 12, utterance information as a population may be collected.

If appearance frequency of each word is simply counted, generally well-used words (such as “ELECTRIC CAR”, “HOME” and so on) not representing specific operation status are often extracted as keywords. In this case, as a method for calculating the score, a statistical quantity such as TF-IDF may be used as the appearance frequency. For example, the number of keywords to be extracted may be fixed as ten in order of higher score, or determined by a threshold of the score.

The keyword extraction unit 31 displays keywords (selected at S403) via the display unit 13 (S403).

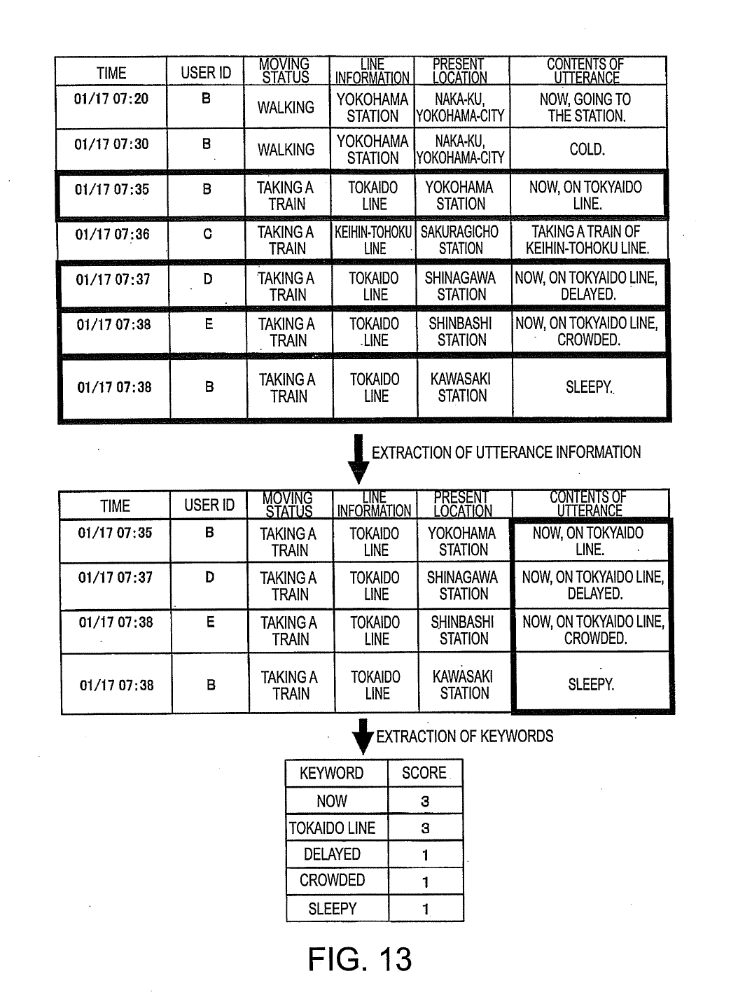

In the third embodiment, assume that the moving status is “TAKING A TRAIN” and line information is “TOKAIDO LINE”. Processing of the keyword extraction unit 31 is explained by referring to utterance information shown in FIG. 13. In FIG. 13, an upper side table and a middle side table are same as those in FIG. 5. Briefly, the upper side table represents utterance information stored in the utterance storage unit 62 of the server 5, and the middle side table represents utterance information extracted with a retrieval query “TOKAIDO LINE” (line name) by the extraction unit 12 from the utterance storage unit 62 via the retrieval unit 52 of the server 5.

At S401, as to four utterance information extracted, the keyword extraction unit 31 applies morphological analysis to contents of utterance (part surrounded by thick frame in the middle table of FIG. 13), and extracts five keywords “NOW”, “TOKAIDO LINE”, “DELAYED”, “CROWDED” and “SLEEPY”.

At S402, the keyword extraction unit 31 calculates an appearance frequency of each keyword in all utterance information extracted, and selects at least one keyword from the all utterance information. For example, a keyword “NOW” appears three times in the four utterance information of the middle table of FIG. 13. Accordingly, a score thereof is “3”. If the keyword extraction unit 31 selects five keywords in order of higher score, the keyword extraction unit 31 selects all keywords extracted.

At S403, the keyword extraction unit 31 displays selected keywords “NOW”, “TOKAIDO LINE”, “DELAYED”, “CROWDED” and “SLEEPY”.

As mentioned-above, processing of the keyword extraction unit 31 of the third embodiment is already explained.

According to the third embodiment, the user A can know operation status of a railway which the user A is presently utilizing or will utilize from now on by confirming keywords extracted from utterances of another user who is utilizing the railway.

(Modification)

In the third embodiment, the measurement unit 10, the estimation unit 11, the extraction unit 12, the display unit 13, the keyword extraction unit 31 and the line storage unit 61, are located at a side of the information processing apparatus 3. However, component thereof is not limited to this example. For example, the information processing apparatus 3 may include the measurement unit 10 and the display unit 13 while the server 5 may include estimation unit 11, the extraction unit 12, the keyword extraction unit 31 and the line storage unit 61. In this modification example, by executing S102-S103 of FIG. 3 at the server 5, the third embodiment can be applied as a service to utilize cloud.

As to the first, second and third embodiments, utterance information can be automatically extracted from a plurality of users in a specific status of the railway, and presented to the predetermined user.

In the disclosed embodiments, the processing can be performed by a computer program stored in a computer-readable medium.

In the embodiments, the computer readable medium may be, for example, a magnetic disk, a flexible disk, a hard disk, an optical disk (e.g., CD-ROM, CD-R, DVD), an optical magnetic disk (e.g., MD). However, any computer readable medium, which is configured to store a computer program for causing a computer to perform the processing described above, may be used.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus for extracting utterance information of at least one user who utilizes a network community from a server, comprising:
a measurement unit configured to measure a present location and an acceleration representing a rate of a specific user's move;
an estimation unit configured to estimate a moving status of the specific user based on the acceleration, and to estimate a line information which the specific user is presently utilizing or will utilize based on the present location and the moving status;
an extraction unit configured to extract at least one utterance information related to the line information from the server; and
a display unit configured to display the at least one utterance information.

2. The apparatus according to claim 1, further comprising:
an acquisition unit configured to acquire utterance information of the specific user;
wherein the extraction unit extracts the at least one utterance information from the server, based on the utterance information of the specific user and the line information.

3. The apparatus according to claim 1, wherein
the extraction unit analyzes the at least one utterance information, and estimates utterance information of another user who is utilizing the line information from the at least one utterance information, and
the display unit displays the utterance information of another user.

4. The apparatus according to claim 1,
wherein the extraction unit extracts the at least one utterance information in a predetermined period prior to the present time.

5. The apparatus according to claim 1, further comprising:
a keyword extraction unit configured to extract at least one keyword related to the line information from the at least one utterance information.

6. The apparatus according to claim 2, wherein,
when another user replies to or transfers the at least one utterance information,
the extraction unit further extracts utterance information related to the traffic route from the server, based on the at least one utterance information replied or transferred.

7. The apparatus according to claim 1, wherein
the moving status represents whether the specific user is presently utilizing a railway, walking, or resting.

8. An information processing method for extracting utterance information of at least one user who utilizes a network community from a server, comprising:
measuring a present location and an acceleration representing a rate of a specific user's move;
estimating a moving status of the specific user based on the acceleration;
estimating a line information which the specific user is presently utilizing or will utilize based on the present location and the moving status;
extracting at least one utterance information related to the line information from the server; and
displaying the at least one utterance information.
